(19) United States
(12) Patent Application Publication
(10) Pub. No.: US 2024/0282506 A1
(43) Pub. Date: Aug. 22, 2024

(54) COIL DEVICE

(71) Applicant: TDK CORPORATION, Tokyo (JP)

(72) Inventors: Hirofumi Sasaki, Tokyo (JP); Ryosuke Iinuma, Tokyo (JP)

(73) Assignee: TDK CORPORATION, Tokyo (JP)

(21) Appl. No.: 18/441,190

(22) Filed: Feb. 14, 2024

(30) Foreign Application Priority Data
Feb. 17, 2023 (JP) 2023-023577

(51) Int. Cl. H01F 27/26; H01F 27/32

(52) U.S. Cl. CPC H01F 27/266; H01F 27/324

(57) ABSTRACT

A coil device includes: a conductor including a winding portion; and a core including a center core portion passing inside the winding portion. The center core portion includes an outer peripheral surface contacted with the winding portion and a center core groove portion recessed inward from the outer peripheral surface.

### BACKGROUND OF THE INVENTION

### 1. TECHNICAL FIELD

The present disclosure relates to a coil device that can be suitably used as, for example, an inductor.

### 2. DESCRIPTION OF THE RELATED ART

A coil device as disclosed in JP 2006-286658 A is known as a surface-mounted inductor. In the coil device as disclosed in JP 2006-286658 A, a coil is housed in a pot core.

In such a coil device, heat generated by the coil is less likely to be transferred to the pot core, and the coil tends to have a high temperature when a current flows through the coil. Therefore, it is required to improve the heat dissipation of the coil device.

### CITATION LIST

### Patent Literature

Patent Literature 1: JP 2006-286658 A

### SUMMARY OF THE INVENTION

The present disclosure has been made in view of the above circumstances, and an object of the present disclosure is to provide a coil device excellent in heat dissipation.

In order to achieve the above object, a coil device according to the present disclosure includes:
1. A coil device comprising:
   a conductor including a winding portion; and
   a core including a center core portion passing inside the winding portion,
   in which the center core portion includes an outer peripheral surface contacted with the winding portion and a center core groove portion recessed inward from the outer peripheral surface.

With such a configuration, a heat transfer material having a high thermal conductivity can be filled in the center core groove portion. The winding portion of the conductor can release heat of the winding portion to the core via the heat transfer material filled in the center core groove portion. Thus, heat dissipation of the coil device is improved.

A heat transfer material having a higher thermal conductivity than air may be filled in the center core groove portion. The heat transfer material having a heat transfer property higher than that of air allows heat of the winding portion to be more effectively transferred to the core.

The heat transfer material may be in contact with the winding portion. Further, the heat transfer material preferably enters spaces in the conductor. By the contact between the heat transfer material and the winding portion, the heat of the winding portion is more efficiently dissipated via the heat transfer material.

The heat transfer material may contain a filler-containing resin. Such a heat transfer material has a higher thermal conductivity than air, and the heat dissipation of the coil device can be improved as compared with a case where the heat transfer material is not present.

The core may include a bottom wall portion at an end of the center core portion, and the bottom wall portion may include a bottom surface contacted with the winding portion and a bottom groove portion recessed from the bottom surface. With such a configuration, the heat transfer material can be easily spread to the bottom groove portion, and the heat dissipation of the coil device can be more effectively improved.

Preferably, the center core groove portion and the bottom groove portion are connected to each other. With such a configuration, as the heat transfer material flows into the center core groove portion, the heat transfer material can be spread to the bottom groove portion.

The number of center core groove portions may be plural. With such a configuration, the winding portion and the center core portion can be in contact with each other in a wider area via the heat transfer material, and the heat dissipation is further improved.

The core may be a pot core including a side wall portion surrounding the center core portion, and the core may have a recessed space formed between the center core portion and the side wall portion. The coil device having such a configuration is particularly likely to retain heat, but even in a case of such a configuration, it is possible to sufficiently dissipate the heat of the winding portion.

The coil device may further include a second core attached to the side wall portion. The side wall portion may have a cutout portion, and the winding portion may include leadout portions extending substantially linearly along a tangent line of the center core portion and led out toward the cutout portion. The center core groove portion may be near the cutout portion. With such a configuration, the coil device can be easily manufactured, and the coil device is also excellent in heat dissipation and can be preferably used particularly at a high frequency.

### BRIEF DESCRIPTION OF THE DRAWINGS

FIG. 1 is a perspective view of a coil device according to a first embodiment of the present disclosure;

FIG. 2 is a perspective view illustrating an internal configuration of a first core;

FIG. 3 is a perspective view of the first core;

FIG. 4 is a perspective view of a winding portion and terminals;

FIG. 5 is a cross-sectional view taken along line V-V illustrated in FIG. 2;

FIG. 6 is a partial perspective view of a first core of a coil device according to a second embodiment;

FIG. 7 is a partial perspective view of a first core of a coil device according to a third embodiment; and

FIG. 8 is a perspective view of a first core of a coil device according to a fourth embodiment.

### DETAILED DESCRIPTION

Hereinafter, embodiments of the present disclosure will be described with reference to the drawings. Illustrated contents are merely schematic and exemplary contents for understanding the present disclosure, and appearances, dimensional ratios, and the like may be different from the actual ones. Further, the present disclosure is not limited to the following embodiments.

### First Embodiment

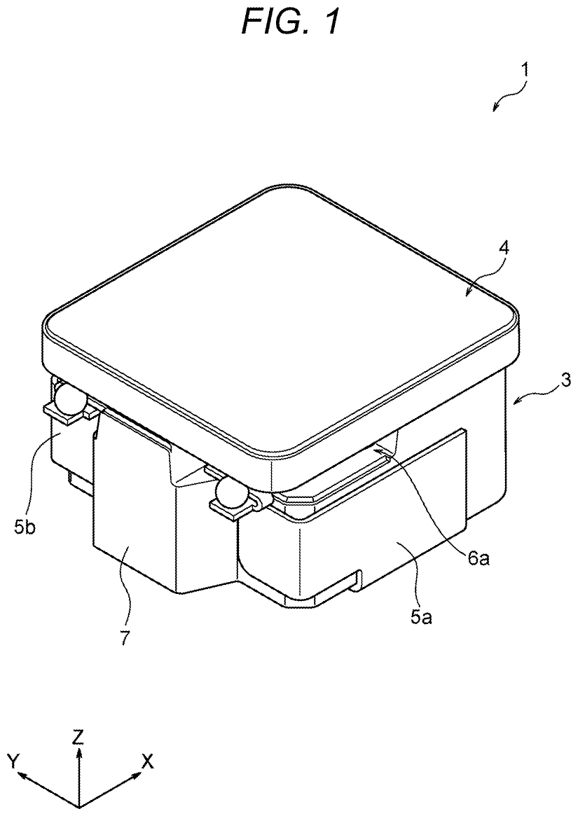

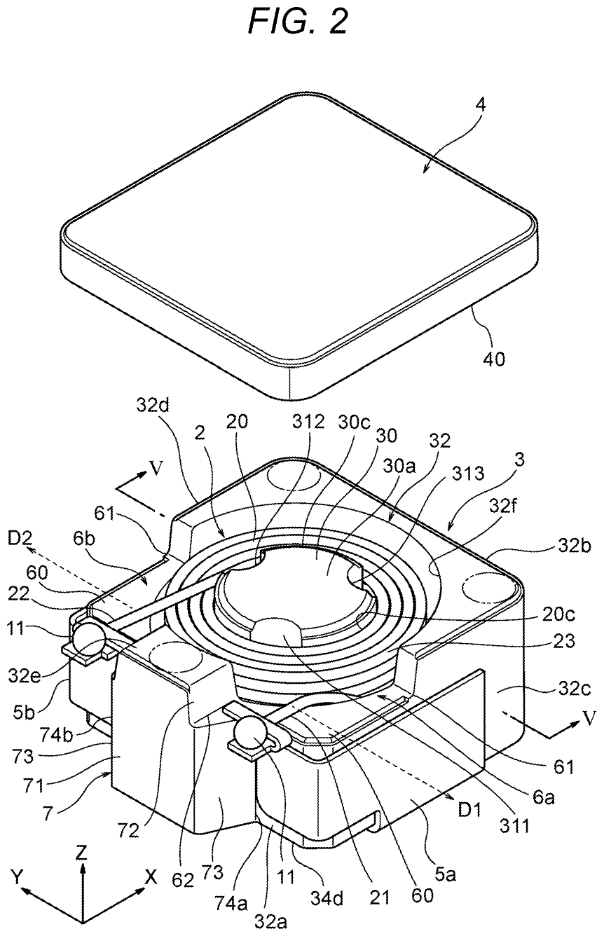

A coil device 1 according to a first embodiment of the present disclosure illustrated in FIG. 1 functions as, for example, an inductor and is mounted on a filter circuit or the like of various electronic devices. As illustrated in FIG. 2, the coil device 1 includes a winding portion 20 formed by spirally winding a wire 2 formed of a conductor. The coil device 1 may further include a first core 3, a second core 4, and terminals 5a and 5b.

The wire 2 includes conductive a conductive core wire such as a round wire or a flat wire made of copper, for example. The wire 2 may be an insulated coated wire in which the conductive core wire is coated with an insulating film. The wire 2 may be a self-fusion wire in which a fusion layer is formed. A diameter of the wire 2 is, for example, 10 to 400 μm. The winding portion 20 is, for example, an air-core coil, and is provided in the first core 3. A winding axis of the winding portion 20 is perpendicular to an installation surface of the coil device 1 (a surface facing a substrate on which the coil device 1 is installed). The number of layers of the winding portion 20 in a radial direction is plural, and the wire 2 is wound so as to reciprocate along the winding axis in at least a part of the winding portion 20.

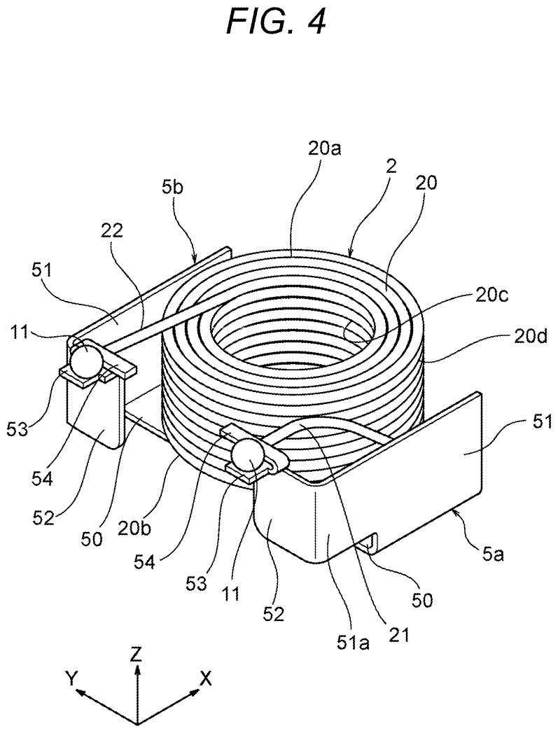

As illustrated in FIG. 4, the wire 2 further includes leadout portions 21 and 22 led out from the winding portion 20 in addition to the winding portion 20. The leadout portion 21 extends from the winding portion 20 to one end of the wire 2, and the leadout portion 22 extends from the winding portion 20 to the other end of the wire 2. The leadout portions 21 and 22 are led out in the same direction. Therefore, the leadout portions 21 and 22 can be led out from the winding portion 20 while suppressing formation of the wire 2. Further, in the winding portion 20, the number of turns of the wire 2 can be increased to adjust inductance. The leadout portions 21 and 22 may be led out in different directions. The leadout portions 21 and 22 are led out in parallel, and may be led out non-parallel.

An extending direction (leadout direction) of the leadout portions 21 and 22 is a direction parallel to an X axis. Alternatively, the extending direction of the leadout portions 21 and 22 is a direction inclined at a predetermined angle along an XY plane with respect to the X axis. Here, the predetermined angle is not particularly limited, and is less than 20 degrees.

Hereinafter, one end of the winding portion 20 in a winding axis direction is referred to as a first end 20a, and the other end of the winding portion 20 in the winding axis direction is referred to as a second end 20b. The leadout portion 21 is led out from the winding portion 20 toward a cutout portion. The leadout portion 21 extends substantially linearly along a tangent line of an outer peripheral surface 30c of a center core portion 30. The leadout portion 22 is led out from the winding portion 20 toward a cutout portion. The leadout portion 22 extends substantially linearly along the tangent line of the outer peripheral surface 30c of the center core portion 30. The leadout portion 21 is led out from the second end 20b of the winding portion 20. However, the leadout portion 21 may be led out from a position between the first end 20a and the second end 20b of the winding portion 20. For example, the leadout portion 21 may be led out from a position closer to the first end 20a or the second end 20b than the center of the winding portion 20 in the winding axis direction. Alternatively, the leadout portion 21 may be led out from the center of the winding portion 20 in the winding axis direction. The leadout portion 22 is led out from the first end 20a of the winding portion 20. However, the leadout portion 22 may be led out from a position between the first end 20a and the second end 20b of the winding portion 20. For example, the leadout portion 22 may be led out from a position closer to the first end 20a or the second end 20b than the center of the winding portion 20 in the winding axis direction. Alternatively, the leadout portion 21 may be led out from the center of the winding portion 20 in the winding axis direction.

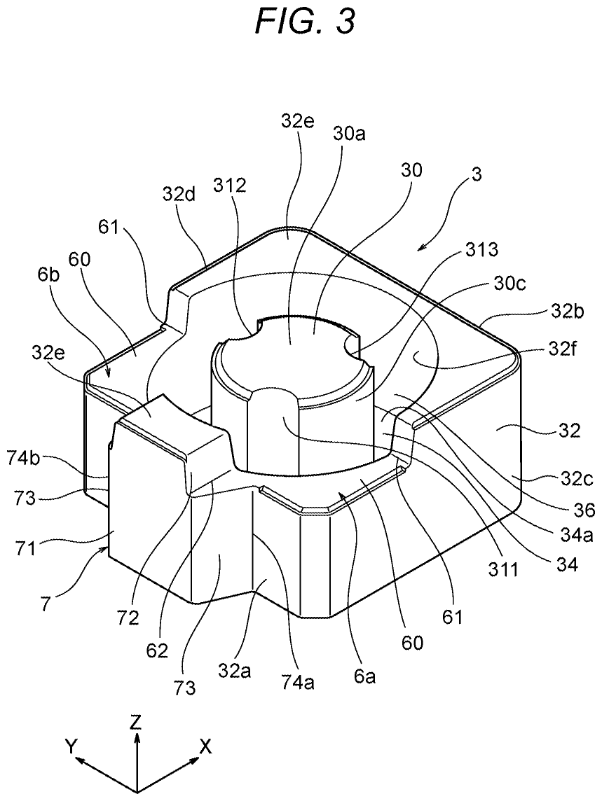

As illustrated in FIG. 3, the first core 3 is a pot core, and is formed of a material containing a magnetic material and a resin. In the present embodiment, the first core 3 mainly contains metal magnetic material particles. Examples of the metal magnetic material particles include Fe-Ni alloy powder, Fe-Si alloy powder, Fe-Si-Cr alloy powder, Fe-Co alloy powder, Fe-Si-Al alloy powder, and amorphous iron. However, the first core 3 may contain ferrite particles or the like instead of the metal magnetic material particles. Examples of the ferrite particles include Ni-Zn-based ferrite and Mn-Zn-based ferrite. Examples of the resin contained in the first core 3 include an epoxy resin, a phenol resin, a polyester resin, a polyurethane resin, a polyimide resin, other synthetic resins, and other nonmagnetic materials. The first core 3 is formed by powder compaction or injection molding of a material containing the above-described magnetic material and a resin. The first core 3 may mainly contain the ferrite particles instead of the metal magnetic material particles. Alternatively, the first core 3 may be a sintered body of the metal magnetic material.

The first core 3 includes, for example, a center core portion 30, a side wall portion 32, and a bottom wall portion 34. The center core portion 30 has a columnar shape and protrudes from a central portion of the bottom wall portion 34. The center core portion 30 may protrude at a position offset from the central portion of the bottom wall portion 34 in the radial direction. A shape of the center core portion 30 is not limited to the shape illustrated in FIG. 3, and may be, for example, a quadratic pole, an octagonal pole, or another polygonal pole. As illustrated in FIGS. 2 and 3, the winding portion 20 is provided on an outer peripheral surface 30c of the center core portion 30. The center core portion 30 is disposed on an inner side of the winding portion 20 in the radial direction, and passes inside the winding portion 20 along the winding axis.

A length of the center core portion 30 in an axial direction may be larger than a length of the winding portion 20 in the winding axis direction. Hereinafter, one end of the center core portion 30 in the axial direction is referred to as a first end 30a, and the other end of the center core portion 30 in the axial direction is referred to as a second end 30b.

As illustrated in FIGS. 2 and 3, center core groove portions 311, 312, and 313 recessed inward with respect to the outer peripheral surface 30c are formed in the outer peripheral surface 30c of the center core portion 30. The center core groove portions 311, 312, and 313 extend from the first end 30a to the second end 30b of the center core portion 30 in a Z-axis direction. The center core groove portions 311, 312, and 313 extend continuously and linearly from the first end 30a to the second end 30b of the center core portion 30. Therefore, a length of the center core groove portions 311, 312, and 313 in the Z-axis direction is equal to a length of the center core portion 30 in the Z-axis direction. An outer periphery of an upper surface of the center core portion 30 is cut out to form the center core groove portions 311, 312, and 313 at the first end 30a of the center core portion 30.

Surfaces of the center core groove portions 311, 312, and 313 are smoothly connected to the outer peripheral surface 30c. Arrangement of the center core groove portions 311, 312, and 313 is not particularly limited, and the center core groove portions 311, 312, and 313 may be arranged at an equal distance on the outer peripheral surface 30c of the center core portion 30.

A cross-sectional shape of each of the center core groove portions 311, 312, and 313 (a cross-sectional shape taken along a plane parallel to an XY plane) is substantially semicircular, and inner walls of the center core groove portions 311, 312, and 313 are smoothly curved. However, the cross-sectional shape of each of the center core groove portions 311, 312, and 313 is not limited thereto.

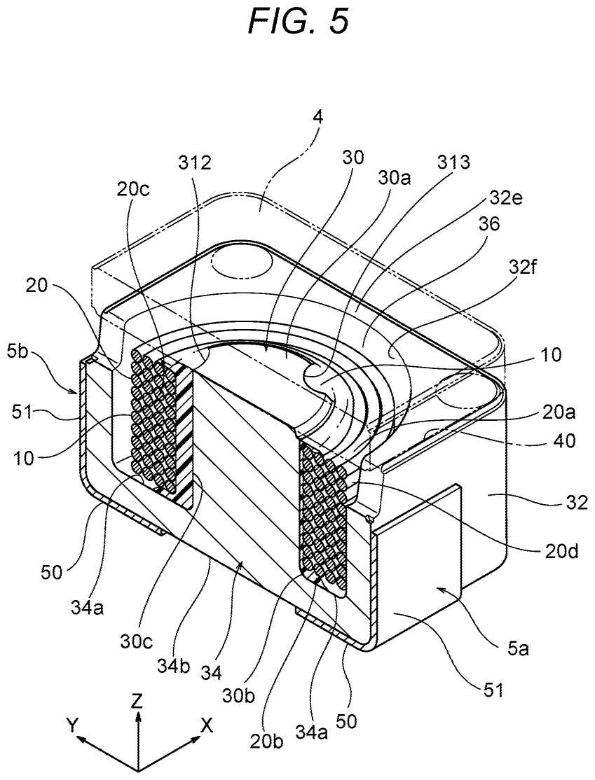

As illustrated in FIG. 5, the first end 20a of the winding portion 20 is offset from the first end 30a of the center core portion 30 toward the installation surface of the coil device 1 in the axial direction of the center core portion 30. Therefore, a leadout position of the leadout portion 21 (FIG. 2) can be adjusted in the axial direction of the center core portion 30 according to a offset width of the first end 20a. Thus, the leadout portion 21 can be led out from the winding portion 20 while suppressing the formation of the wire 2.

As illustrated in FIGS. 2 and 3, the side wall portion 32 protrudes from an outer edge portion of the bottom wall portion 34 in the same direction as the center core portion 30. The side wall portion 32 is positioned outside the center core portion 30 in the radial direction and surrounds the center core portion 30 from outside in the radial direction. The side wall portion 32 is positioned outside the winding portion 20 in the radial direction and surrounds the winding portion 20 from outside in the radial direction. An outer peripheral surface of the side wall portion 32 is substantially quadrangular as viewed from the winding axis direction of the winding portion 20. However, a shape of the outer peripheral surface of the side wall portion 32 is not limited to a quadrangle, and may be a hexagon, an octagon, another polygon, a circle, an ellipse, or other shapes.

The side wall portion 32 includes a first surface 32a, a second surface 32b facing the first surface 32a, a third surface 32c, and a fourth surface 32d facing the third surface 32c. In FIGS. 2 and 3 and the like, the X axis is an axis parallel to a direction in which the first surface 32a and the second surface 32b face each other. A Y axis is an axis parallel to a direction in which the third surface 32c and the fourth surface 32d face each other. A Z axis is an axis perpendicular to the X axis and the Y axis. The Z axis is an axis parallel to the winding axis direction of the winding portion 20, the axial direction of the center core portion 30, and the axial direction of the side wall portion 32 described above.

A ridge portion positioned between the first surface 32a and the third surface 32c is chamfered. Similarly, a ridge portion positioned between the first surface 32a and the fourth surface 32d is chamfered. A ridge portion positioned between the second surface 32b and the third surface 32c is curved in a cross-section of the side wall portion 32. Similarly, a ridge portion positioned between the second surface 32b and the fourth surface 32d is curved in the cross-section of the side wall portion 32. However, the chamfered portions and the curved portions are not essential and may be omitted.

The side wall portion 32 further includes an end surface 32e and an inner peripheral surface 32f. The end surface 32e is a surface formed one end of the side wall portion 32 in the axial direction. The end surface 32e is formed at an opening edge of a recessed space 36 located between the center core portion 30 and the side wall portion 32, and extends in a direction perpendicular to the axial direction of the side wall portion 32. The end surface 32e is positioned on one side (Z-axis positive direction side) along the Z axis with respect to the first end 20a of the winding portion 20. Therefore, for example, when the side wall portion 32 is viewed along the X axis from a second surface 32b side of the side wall portion 32, the first end 20a is hidden by the side wall portion 32 (the second surface 32b) and is not exposed to the second surface 32b side.

The inner peripheral surface 32f extends along the outer peripheral surface 30c of the center core portion 30. A shape of the inner peripheral surface 32f viewed in a Z-axis direction is a circular shape, and may be, for example, a quadrangular shape, an octagonal shape, or another polygonal shape.

As illustrated in FIG. 5, the bottom wall portion 34 includes a bottom surface 34a and an installation surface 34b. The bottom surface 34a is formed at the bottom of the recessed space 36 and extends along a circumferential direction of the center core portion 30. The second end 20b of the winding portion 20 is disposed on the bottom surface 34a.

The installation surface 34b is positioned on a side opposite to the bottom surface 34a along the Z axis. The installation surface 34b is a surface perpendicular to the axial direction of the center core portion 30 or the side wall portion 32. In addition, the installation surface 34b is a surface facing the substrate (not illustrated) on which the coil device 1 is installed. In the present embodiment, the installation surface 34b may be referred to as the installation surface of the coil device 1.

As illustrated in FIGS. 2 and 3, the recessed space 36 is a space sandwiched between the outer peripheral surface 30c of the center core portion 30 and the inner peripheral surface 32f of the side wall portion 32, and extends along the circumferential direction of the center core portion 30. The winding portion 20 is accommodated in the recessed space 36.

As illustrated in FIGS. 2 and 3, cutout portions 6a and 6b cut toward the other end of the side wall portion 32 in the axial direction are formed at one end (the end surface 32e) of the side wall portion 32 in the axial direction. The cutout portions 6a and 6b extend in a circumferential direction of the side wall portion 32. Further, the cutout portions 6a and 6b extend from the inner peripheral surface 32f of the side wall portion 32 to the outer peripheral surface (the first surface 32a, the third surface 32c, and the fourth surface 32d) in the radial direction of the side wall portion 32. A length of a part of the inner peripheral surface 32f of the side wall portion 32 cut by the cutout portion 6a or 6b in the circumferential direction may be two times or more, four times or more, six times or more, eight times or more, or ten times or more the diameter of the wire 2.

The leadout portion 21 passes through the cutout portion 6a, and the leadout portion 22 passes through the cutout portion 6b. The leadout portion 21 is led out from the inside to the outside of the side wall portion 32 in the radial direction through the cutout portion 6a. The leadout portion 22 is led out from the inside to the outside of the side wall portion 32 in the radial direction through the cutout portion 6b.

The cutout portion 6a and the cutout portion 6b are separated from each other in the circumferential direction of the side wall portion 32. The cutout portions 6a and 6b are positioned closer to the first surface 32a than the center of the side wall portion 32 in the X-axis direction as a whole. The cutout portion 6a is positioned closer to the third surface 32c than the center of the side wall portion 32 in a Y-axis direction as a whole. The cutout portion 6b is positioned closer to the fourth surface 32d than the center of the side wall portion 32 in the Y-axis direction as a whole.

For example, 1/8 or more of the end surface 32e of the side wall portion 32 may be cut out to form the cutout portion 6a or 6b. Alternatively, 1/6 or more of the end surface 32e of the side wall portion 32 may be cut out to form the cutout portion 6a or 6b. Alternatively, 1/5 or more of the end surface 32e of the side wall portion 32 may be cut out to form the cutout portion 6a or 6b.

For example, 1/4 or more of the end surface 32e of the side wall portion 32 may be cut out to form the cutout portions 6a and 6b. Alternatively, 1/3 or more of the end surface 32e of the side wall portion 32 may be cut out to form the cutout portions 6a and 6b.

The cutout portion 6a and the cutout portion 6b have the same shape, and may also have different shapes. For example, one of the cutout portions 6a and 6b may extend longer in the circumferential direction of the side wall portion 32 than the other.

The cutout portion 6a is continuously formed from the first surface 32a to the third surface 32c in the circumferential direction of the side wall portion 32. The cutout portion 6a is formed across the surfaces of the side wall portion 32, and the ridge portion between the first surface 32a and the third surface 32c is cut to form the cutout portion 6a. A first end 61, which is one end of the cutout portion 6a in an extending direction, is positioned at the center of the third surface 32c in the X-axis direction. Here, the center of the third surface 32c in the X-axis direction includes a position shifted from the center of the third surface 32c in the X-axis direction toward a positive X-axis direction or a negative X-axis direction by about 5 to 10% of the length of the third surface 32c in the X-axis direction. The first end 61 may be positioned closer to the first surface 32a or may be positioned closer to the second surface 32b than the center of the third surface 32c along the X axis.

A second end 62, which is the other end of the cutout portion 6a in the extending direction, is positioned at a position spaced apart from the center of the first surface 32a in the Y-axis direction toward the third surface 32c by a predetermined distance along the Y axis. Here, the predetermined distance is, for example, a distance corresponding to 5 to 30% of a length of the first surface 32a in the Y-axis direction.

The first end 61 of the cutout portion 6a may be positioned at a position (including the vicinity of the position) spaced apart from a leadout position 23 of the leadout portion 21 on the winding portion 20 in the radial direction of the winding portion 20. Here, the vicinity of the position includes a position shifted from the position by about 5 to 10% of the length of the third surface 32c in the X-axis direction along the X axis.

The cutout portion 6b is continuously formed from the first surface 32a to the fourth surface 32d in the circumferential direction of the side wall portion 32. The cutout portion 6b is formed across the surfaces of the side wall portion 32, and the ridge portion between the first surface 32a and the fourth surface 32d is cut to form the cutout portion 6b. A first end 61, which is one end of the cutout portion 6b in an extending direction, is positioned at the center of the fourth surface 32d in the X-axis direction. Here, the center of the fourth surface 32d in the X-axis direction includes a position shifted from the center of the fourth surface 32d in the X-axis direction toward a positive X-axis direction or a negative X-axis direction by about 5 to 10% of the length of the fourth surface 32d in the X-axis direction. The first end 61 may be positioned closer to the first surface 32a or may be positioned closer to the second surface 32b than the center of the fourth surface 32d along the X axis.

A second end 62, which is the other end of the cutout portion 6b in the extending direction, is positioned at a position spaced apart from the center of the first surface 32a in the Y-axis direction toward the fourth surface 32d by a predetermined distance along the Y axis. Here, the predetermined distance is, for example, a distance corresponding to 5 to 30% of a length of the first surface 32a in the Y-axis direction.

The first end 61 of the cutout portion 6b may be positioned at a position (including the vicinity of the position) spaced apart from a leadout position 23 of the leadout portion 22 on the winding portion 20 in the radial direction of the winding portion 20. Here, the vicinity of the position includes a position shifted from the position by about 5 to 10% of the length of the fourth surface 32d in the X-axis direction along the X axis.

As illustrated in FIGS. 2 and 3, at least a part of the leadout portion 21 is exposed in a direction D1 in FIG. 2 through the cutout portion 6a. Here, the direction D1 is a direction perpendicular to the extending direction of the leadout portion 21 and the axial direction (Z-axis direction) of the side wall portion 32. Therefore, at least a part of the leadout portion 21 is not hidden by the side wall portion 32 (third surface 32c) and is exposed to the outside (third surface 32c side) through the cutout portion 6a when viewed from the direction D1. In a case where the extending direction of the leadout portion 21 is the X-axis direction, at least a part of the leadout portion 21 is exposed in the Y-axis direction through the cutout portion 6a. At least a part of the leadout portion 21 is not hidden by the side wall portion 32 (third surface 32c) and is exposed to the outside (third surface 32c side) through the cutout portion 6a when viewed from the Y-axis direction.

In the present embodiment, a part of the leadout portion 21 is exposed to the outside through the cutout portion 6a when viewed from the direction D1 (the Y-axis direction or a direction inclined along the XY plane with respect to the Y axis) in a section (part) of the side wall portion 32 in the circumferential direction between the first end 61 and the second end 62 of the cutout portion 6a (alternatively, a section (part) of the side wall portion 32 along the X axis between the first end 61 of the cutout portion 6a and the first surface 32a). Alternatively, in this section, the entire leadout portion 21 may be exposed to the outside through the cutout portion 6a when viewed from the direction D1. In this case, the entire leadout portion 21 is hidden by the side wall portion 32 (third surface 32c) when viewed from the direction D1.

At least a part of the leadout portion 21 is exposed through the cutout portion 6a in the extending direction of the leadout portion 21 (the X-axis direction or a direction inclined along the XY plane with respect to the X axis). Therefore, at least a part of the leadout portion 21 is not hidden by the side wall portion 32 (first surface 32a) and is exposed to the outside (first surface 32a side) through the cutout portion 6a when viewed from the extending direction of the leadout portion 21.

At least a part of the cutout portion 6a is disposed in parallel with the leadout portion 21 outside the leadout portion 21 in the direction D1. Further, the cutout portion 6a extends in the circumferential direction of the side wall portion 32 so as to cross the leadout portion 21.

When viewed from the direction D1, at least a part of the leadout portion 21 (a part of the leadout portion 21 in the present embodiment) is positioned closer to the end surface 32e than a bottom portion 60 of the cutout portion 6a in the axial direction of the side wall portion 32. Alternatively, the entire leadout portion 21 may be positioned closer to the end surface 32e than the bottom portion 60 in the axial direction of the side wall portion 32. Further, a part of the leadout portion 21 may be disposed so as to be in contact with the bottom portion 60.

At least a part of the leadout portion 22 is exposed in a direction D2 in FIG. 2 through the cutout portion 6b. Here, the direction D2 is a direction perpendicular to the extending direction of the leadout portion 22 and the axial direction (Z-axis direction) of the side wall portion 32. Therefore, at least a part of the leadout portion 22 is not hidden by the side wall portion 32 (fourth surface 32d) and is exposed to the outside (fourth surface 32d side) through the cutout portion 6b when viewed from the direction D2. In a case where the extending direction of the leadout portion 22 is the X-axis direction, at least a part of the leadout portion 22 is exposed in the Y-axis direction through the cutout portion 6b. At least a part of the leadout portion 22 is not hidden by the side wall portion 32 (fourth surface 32d) and is exposed to the outside (fourth surface 32d side) through the cutout portion 6b when viewed from the Y-axis direction.

In the present embodiment, the entire leadout portion 22 is exposed to the outside through the cutout portion 6b when viewed from the direction D2 (the Y-axis direction or the direction inclined along the XY plane with respect to the Y axis) in a section (part) of the side wall portion 32 in the circumferential direction between the first end 61 and the second end 62 of the cutout portion 6b (alternatively, a section (part) of the side wall portion 32 along the X axis between the first end 61 of the cutout portion 6b and the first surface 32a). Alternatively, in this section, a part of leadout portion 22 may be exposed to the outside through the cutout portion 6b when viewed from the direction D2. In this case, a part of the leadout portion 22 is hidden by the side wall portion 32 (fourth surface 32d) when viewed from the direction D2.

At least a part of the leadout portion 22 is exposed through the cutout portion 6b in the extending direction of the leadout portion 22 (the X-axis direction or the direction inclined along the XY plane with respect to the X axis). Therefore, at least a part of the leadout portion 22 is not hidden by the side wall portion 32 (first surface 32a) and is exposed to the outside (first surface 32a side) through the cutout portion 6b when viewed from the extending direction of the leadout portion 22.

At least a part of the cutout portion 6b is disposed in parallel with the leadout portion 22 outside the leadout portion 22 in the direction D2. Further, the cutout portion 6b extends in the circumferential direction of the side wall portion 32 so as to cross the leadout portion 22.

When viewed from the direction D2, at least a part of the leadout portion 22 (the entire leadout portion 22 in the present embodiment) is positioned closer to the end surface 32e than a bottom portion 60 of the cutout portion 6b in the axial direction of the side wall portion 32. A part of the leadout portion 22 may be positioned closer to the end surface 32e than the bottom portion 60 in the axial direction of the side wall portion 32. Further, a part of the leadout portion 22 may be disposed so as to be in contact with the bottom portion 60.

At least a part of the winding portion 20 in the winding axis direction (for example, the first end 20a of the winding portion 20 or the vicinity thereof) is exposed in the direction D1 (the Y-axis direction or the direction inclined along the XY plane with respect to the Y axis) through the cutout portion 6a. Therefore, at least a part of the winding portion 20 is not hidden by the side wall portion 32 (third surface 32c) and is exposed to the outside (third surface 32c side) through the cutout portion 6a when viewed from the direction D1.

At least a part of the winding portion 20 in the winding axis direction (for example, the first end 20a of the winding portion 20 or the vicinity thereof) is exposed in the direction D2 (the Y-axis direction or the direction inclined along the XY plane with respect to the Y axis) through the cutout portion 6b. Therefore, at least a part of the winding portion 20 is not hidden by the side wall portion 32 (fourth surface 32d) and is exposed to the outside (fourth surface 32d side) through the cutout portion 6b when viewed from the direction D2.

At least a part of the winding portion 20 in the winding axis direction is exposed in the extending direction of the leadout portions 21 and 22 (the X-axis direction or the direction inclined along the XY plane with respect to the X axis) through the cutout portions 6a and 6b. Therefore, at least a part of the winding portion 20 is not hidden by the side wall portion 32 (first surface 32a), and is exposed to the outside (first surface 32a side) through the cutout portions 6a and 6b when viewed from the extending direction of the leadout portions 21 and 22.

When viewed from the direction D1, at least a part of the winding portion 20 in the winding axis direction is positioned closer to the end surface 32e than the bottom portion 60 of the cutout portion 6a in the axial direction of the side wall portion 32. When viewed from the direction D2, at least a part of the winding portion 20 in the winding axis direction is positioned closer to the end surface 32e than the bottom portion 60 of the cutout portion 6b in the axial direction of the side wall portion 32.

As illustrated in FIGS. 2 and 3, the side wall portion 32 may further include a protrusion 7. The protrusion 7 protrudes outward in the radial direction from the outer peripheral surface (first surface 32a) of the side wall portion 32. At least a part of the protrusion 7 is positioned between the cutout portion 6a and the cutout portion 6b in the circumferential direction of the side wall portion 32. The protrusion 7 includes a first portion 71. The protrusion 7 may further include a second portion 72 continuous with the first portion 71 along the Z axis.

The first portion 71 protrudes outward in the radial direction from the outer peripheral surface of the side wall portion 32. The first portion 71 is formed at the center of the first surface 32a in the Y-axis direction. The center of the first surface 32a in the Y-axis direction corresponds to the center of the first surface 32a in the circumferential direction of the side wall portion 32. The first portion 71 extends from the installation surface 34b (FIG. 5) of the bottom wall portion 34 to the bottom portions 60 of the cutout portions 6a and 6b in the axial direction of the side wall portion 32. Inclined surfaces 73 are formed on opposite sides of the first portion 71 in the Y-axis direction. An interval between one inclined surface 73 and the other inclined surface 73 decreases toward an outer side of the side wall portion 32 in the radial direction. Therefore, the first portion 71 has a tapered shape that tapers outward in the radial direction of the side wall portion 32.

The second portion 72 protrudes from the bottom portions 60 of the cutout portions 6a and 6b toward one side of the side wall portion 32 (the side opposite to the installation surface of the coil device 1) in the axial direction. A length of the second portion 72 in the Y-axis direction is smaller than a length of the first portion 71 (including the inclined surface 73) in the Y-axis direction. A protrusion length of the second portion 72 along the Z axis is larger than the diameter of the wire 2, and may be two times or more, four times or more, six times or more, eight times or more, or ten times or more the diameter of the wire 2. A top surface of the second portion 72 forms a part of the end surface 32e of the side wall portion 32. Therefore, in a case where the second core 4 is disposed on (bonded to) the end surface 32e as described later, stability (adhesive strength) of the second core 4 with respect to the end surface 32e can be secured.

The second portion 72 is positioned between the second end 62 of the cutout portion 6a and the second end 62 of the cutout portion 6b in the circumferential direction of the side wall portion 32. The second portion 72 is positioned between the leadout portion 21 and the leadout portion 22 in the circumferential direction of the side wall portion 32. Therefore, the second portion 72 facilitates insulation between the leadout portion 21 and the leadout portion 22.

The side wall portion 32 may further include recesses 74a and 74b adjacent to the protrusion 7 in the circumferential direction of the side wall portion 32 (that is, the Y-axis direction). Each of the recesses 74a and 74b is defined (formed) by the first surface 32a and the inclined surface 73 intersecting (inclined with respect to) the first surface 32a. The recess 74a is positioned on one side of the protrusion 7 in the Y-axis direction. The recess 74b is positioned on the other side of the protrusion 7 in the Y-axis direction. The recesses 74a and 74b are recessed toward the inner peripheral surface 32f of the side wall portion 32. Further, the recesses 74a and 74b extend from the installation surface 34b (FIG. 5) of the bottom wall portion 34 to the bottom portions 60 of the cutout portions 6a and 6b in the axial direction of the side wall portion 32.

As illustrated in FIGS. 2 and 3, the terminals 5a and 5b are formed of plate-like conductors such as metal, and are attached to the outer peripheral surface of the side wall portion 32. The terminal 5a is attached across the first surface 32a and the third surface 32c of the side wall portion 32 and the installation surface 34b (FIG. 5) of the bottom wall portion 34. The terminal 5b is attached across the first surface 32a and the fourth surface 32d of the side wall portion 32 and the installation surface 34b of the bottom wall portion 34.

As illustrated in FIG. 4, the terminal 5a includes a wire connecting portion 53 connected to the leadout portion 21. The terminal 5a may further include, for example, an installation portion 50, a first side portion 51, a second side portion 52, and a crimping portion 54. The terminal 5b includes a wire connecting portion 53 connected to the leadout portion 22. The terminal 5b may further include, for example, an installation portion 50, a first side portion 51, a second side portion 52, and a crimping portion 54.

As illustrated in FIG. 5 (see FIG. 3, as appropriate), the installation portion 50 of the terminal 5a is disposed on the installation surface 34b of the bottom wall portion 34 on the third surface 32c side. The installation portion 50 of the terminal 5b is disposed on the installation surface 34b of the bottom wall portion 34 on the fourth surface 32d side. The installation portion 50 is connected to the substrate (not illustrated) on which the coil device 1 is installed via a solder, a conductive adhesive, or the like.

As illustrated in FIGS. 2 and 4 (see FIG. 3, as appropriate), the first side portion 51 is continuous with the installation portion 50 and extends in a direction orthogonal to the installation portion 50. The first side portion 51 may include a narrow portion 51a having a smaller width along the Z axis than other portions. The first side portion 51 of the terminal 5a is disposed on the third surface 32c, and the first side portion 51 of the terminal 5b is disposed on the fourth surface 32d so as to face the first side portion 51 of the terminal 5b along the Y axis. A fillet such as a solder may be formed on the first side portion 51.

The second side portion 52 is continuous with the first side portion 51 and extends in a direction orthogonal to the first side portion 51. The first side portion 51 of the terminal 5a is disposed on the first surface 32a on one side of the protrusion 7 in the Y-axis direction. The first side portion 51 of the terminal 5b is disposed on the first surface 32a on the other side of the protrusion 7 in the Y-axis direction.

The wire connecting portion 53 is continuous with the second side portion 52 and extends in a direction orthogonal to the second side portion 52. The leadout portion 21 is connected to the wire connecting portion 53 of the terminal 5a by welding, and the leadout portion 22 is connected to the wire connecting portion 53 of the terminal 5b by welding. A melting portion (welding ball) 11 is formed on the wire connecting portion 53. The leadout portion 21 or 22 may be connected to the wire connecting portion 53 by using, for example, laser welding, a solder, a conductive adhesive, thermocompression bonding, ultrasonic waves bonding, resistance brazing, ultraviolet curable resin bonding, or the like.

The wire connecting portion 53 of the terminal 5a and the wire connecting portion 53 of the terminal 5b are both disposed on the same side (the first surface 32a side of the side wall portion 32) in the extending direction of the leadout portions 21 and 22 (the X-axis direction or the direction inclined along the XY plane with respect to the X axis). Therefore, the leadout portions 21 and 22 can be led out from the winding portion 20 and further connected to the wire connecting portion 53 of the terminal 5a and the wire connecting portion 53 of the terminal 5b, respectively, while suppressing the formation of the wire 2. Positions of the wire connecting portions 53 of the terminals 5a and 5b are not limited to the positions illustrated in FIGS. 2 and 4.

The wire connecting portion 53 of the terminal 5a is disposed within a range of the recess 74a (inside the recess 74a) when viewed from the axial direction of the side wall portion 32. Further the wire connecting portion 53 of the terminal 5b is disposed within a range of the recess 74b (inside the recess 74b) when viewed from the axial direction of the side wall portion 32. Therefore, in the radial direction of the side wall portion 32, the wire connecting portions 53 of the terminals 5a and 5b are less likely to be disposed at positions spaced apart from the outer peripheral surface of the side wall portion 32 in the radial direction. Therefore, the coil device 1 can be downsized. A part of the wire connecting portion 53 may be disposed outside the range of the recess 74a or 74b (outside the recess 74a or 74b).

The crimping portion 54 is continuous with the wire connecting portion 53 and is formed to be bendable with respect to the wire connecting portion 53. The crimping portion 54 of the terminal 5a crimps the leadout portion 21, and the leadout portion 21 is sandwiched between the crimping portion 54 of the terminal 5a and the wire connecting portion 53. The crimping portion 54 of the terminal 5b crimps the leadout portion 22, and the leadout portion 22 is sandwiched between the crimping portion 54 of the terminal 5b and the wire connecting portion 53. The melting portion 11 may be formed on the crimping portion 54 in addition to the wire connecting portion 53.

As illustrated in FIGS. 1 and 2 (see FIG. 3, as appropriate), the second core 4 is a plate-shaped core and is attached to the end surface 32e of the side wall portion 32. The second core 4 is formed of a material containing a magnetic material and a resin. In the present embodiment, the second core 4 is made of a material different from that of the first core 3, and mainly contains the ferrite particles. The second core 4 is a sintered body of ferrite, but is not limited thereto as long as the second core 4 contains the ferrite particles. The second core 4 may mainly contain the metal magnetic material particles instead of the ferrite particles. Alternatively, the second core 4 may be a sintered body of the metal magnetic material. Although the material of the second core 4 is different from the material of the first core 3 in the present embodiment, the material of the second core 4 may be the same as the material of the first core 3. The permeability of the second core 4 is not particularly limited and may be five times or more the permeability of the first core 3. A plate thickness of the second core 4 is not particularly limited and may be 15% or more of a height of the side wall portion 32 in the axial direction. As the permeability and the plate thickness of the second core 4 are set within the above ranges, occurrence of magnetic saturation can be prevented.

The second core 4 includes an attachment surface 40. The attachment surface 40 is attached to the end surface 32e of the side wall portion 32 with an adhesive or the like. The attachment surface 40 is locally bonded to, for example, regions of the end surface 32e indicated by two-dot chain lines in FIG. 2. Alternatively, the attachment surface 40 may be bonded to the entire end surface 32e.

As illustrated in FIG. 5, the center core groove portions 311, 312, and 313 (see FIG. 3) may be filled with a resin 10 for bonding an inner peripheral surface 20c of the winding portion 20. The winding portion 20 can be fixed to the center core portion 30 by the resin 10. In addition, the winding portion 20 can release heat of the winding portion 20 to the core 3 via the resin 10 disposed in the center core groove portions 311, 312, and 313, so that the heat dissipation of the coil device 1 is improved. As the center core groove portions 311, 312, and 313 are provided, the winding portion 20 and the center core portion 30 can be brought into contact with each other in a wider area, so that the heat dissipation is further improved. Since the resin 10 is in contact with the winding portion 20, the heat of the winding portion 20 is easily transferred to the core 3.

The center core groove portions 311, 312, and 313 extend from the first end 30a to the second end 30b of the center core portion 30 in a Z-axis direction. With such a configuration, the resin 10 can be poured into the center core groove portions 311, 312, and 313 from the first end 30a of the center core portion 30, and the resin 10 and the winding portion 20 can be easily in contact with each other.

From the viewpoint of improving the heat dissipation of the winding portion 20, the resin 10 may enter spaces in the winding portion 20. Further, the resin 10 may be a heat transfer material having a higher thermal conductivity than air. Such a heat transfer material may contain a filler-containing resin. As such a heat transfer material contains the filler, the thermal conductivity is improved, and the heat in the winding portion 20 can be efficiently transferred to the core 3. The heat transfer material may contain an epoxy resin.

A space between the outer peripheral surface 30c of the center core portion 30 and the winding portion 20 at a position where the center core groove portions 311, 312, and 313 are not provided may also be filled with the resin 10. A space between the bottom surface 34a and the second end 20b may be filled with the resin 10 such as an adhesive. Since the surfaces of the center core groove portions 311, 312, and 313 are smoothly connected to the outer peripheral surface 30c, the resin 10 easily flows into the space between the outer peripheral surface 30c of the center core portion 30 and the winding portion 20 at a position where the center core groove portions 311, 312, and 313 are not provided.

The core 3 may be a pot core including the side wall portion 32 surrounding the center core portion 30 and a recessed space 36 between the center core portion 30 and the side wall portion 32. A predetermined interval is provided between the side wall portion 32 and the center core portion 30 at the recessed space 36. The coil device 1 including such a pot core is particularly likely to retain heat, but even in a case of such a configuration, it is possible to sufficiently dissipate the heat of the winding portion 20.

Next, a method for manufacturing the coil device 1 will be described. First, the first core 3, the second core 4, and the terminals 5a and 5b illustrated in FIG. 2 are prepared. Next, the terminals 5a and 5b are bonded to predetermined positions on the outer peripheral surface of the first core 3 illustrated in FIG. 2 with an adhesive or the like. Next, the wire 2 including the winding portion 20 is prepared. Next, as illustrated in FIG. 2, the winding portion 20 is disposed on the center core portion 30 of the first core 3. Next, as illustrated in FIG. 4, the leadout portion 21 is crimped by the crimping portion 54 of the terminal 5a, and is connected to the wire connecting portion 53 by welding or the like. Further, the leadout portion 22 is crimped by the crimping portion 54 of the terminal 5b, and is connected to the wire connecting portion 53 by welding or the like.

Next, as illustrated in FIG. 5, the center core groove portions 311, 312, and 313 are filled with the resin 10. For example, the resin 10 flows along the outer periphery of the first end 30a of the center core portion 30 so that the resin 10 adheres to the first end 20a of the winding portion 20. As a result, the center core groove portions 311, 312, and 313 are filled with the resin 10, and the space between the outer peripheral surface 30c of the center core portion 30 and the inner peripheral surface 20c of the winding portion 20 at a position where the center core groove portions 311, 312, and 313 are not formed is also easily filled with the resin 10.

In addition, a space between the second end 20b of the winding portion 20 and the bottom surface 34a of the bottom wall portion 34 is filled with the resin 10. The resin 10 may flow from the first end 30a of the center core portion 30 into the center core groove portions 311, 312, and 313 to fill the center core groove portions 311, 312, and 313. Even in such a method, the space between the outer peripheral surface 30c of the center core portion 30 and the inner peripheral surface 20c of the winding portion 20 at a position where the center core groove portions 311, 312, and 313 are not formed can also be filled with the resin 10. However, a filling range (area) of the resin 10 is not limited thereto, and for example, a space between an outer peripheral surface 20d of the winding portion 20 and the inner peripheral surface 32f of the side wall portion 32 may be filled with the resin 10.

Next, as illustrated in FIGS. 1 and 2, the second core 4 is bonded to the end surface 32e of the side wall portion 32 with an adhesive or the like. The coil device 1 illustrated in FIG. 1 can be manufactured as described above. A dimension of the coil device 1 is not particularly limited, but a length in the X-axis direction is, for example, 2 to 20 mm, a length in the Y-axis direction is, for example, 2 to 20 mm, and a length in the Z-axis direction is, for example, 1 to 10 mm.

### Second Embodiment

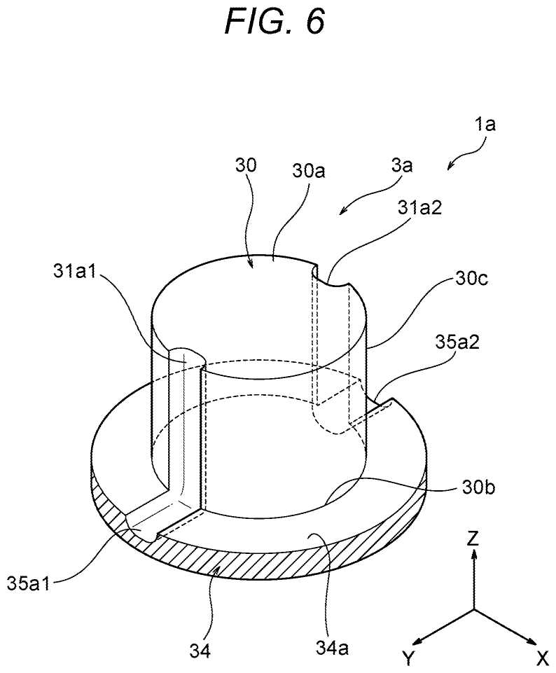

A coil device la of a second embodiment has a similar configuration to that of the coil device 1 of the first embodiment except for the following points. Portions overlapping with the coil device 1 of the first embodiment are denoted by the same reference signs, and a detailed description thereof will be omitted. FIG. 6 illustrates a part of an internal configuration of a first core 3a in the coil device la of the second embodiment.

As illustrated in FIG. 6, the first core 3a includes center core groove portions 31a1 and 31a2 recessed inward with respect to the outer peripheral surface 30c. In addition, the first core 3a includes bottom groove portions 35a1 and 35a2 recessed with respect to the bottom surface 34a.

The center core groove portions 31a1 and 31a2 extend from a first end 30a toward a second end 30b of the center core portion 30 in a Z-axis direction. The center core groove portions 31a1 and 31a2 are disposed at equal distances on the outer peripheral surface 30c of the center core portion 30.

The center core groove portions 31a1 and 31a2 extend continuously and linearly from the first end 30a to the second end 30b of the center core portion 30. Therefore, a length of the center core groove portions 31a1 and 31a2 in the Z-axis direction is equal to a length of the center core portion 30 in the Z-axis direction. An outer periphery of an upper surface of the center core portion 30 is cut out to form the center core groove portions 31a1 and 31a2 at the first end 30a of the center core portion 30. Surfaces of the center core groove portions 31a1 and 31a2 are smoothly connected to the outer peripheral surface 30c.

As illustrated in FIG. 6, the bottom groove portions 35a1 and 35a2 are formed on the bottom surface 34a of the bottom wall portion 34. The bottom groove portions 35a1 and 35a2 extend outward from the outer peripheral surface 30c of the center core portion 30. The bottom groove portions 35a1 and 35a2 extend continuously and linearly from an intersection between the bottom surface 34a of the bottom wall portion 34 and the outer peripheral surface 30c of the center core portion 30 to an inner peripheral surface 32f (see FIG. 3) of a side wall portion 32. The bottom groove portions 35a1 and 35a2 are connected to the center core groove portions 31a1 and 31a2 at the second end 30b of the center core portion 30. Shapes of inner wall surfaces of the bottom groove portions 35a1 and 35a2 are equal to shapes of inner wall surfaces of the center core groove portions 31a1 and 31a2, but the shapes may be different from each other.

As the bottom groove portions 35a1 and 35a2 are formed in the bottom wall portion 34, a resin 10 can also be filled in the bottom groove portions 35a1 and 35a2. Since the center core groove portions 31a1 and 31a2 and the bottom groove portions 35a1 and 35a2 are connected, as the resin 10 is applied to the center core groove portions 31a1 and 31a2, the resin 10 can be spread to the bottom groove portions 35a1 and 35a2. When the resin 10 is spread to the bottom groove portions 35a1 and 35a2, the resin 10 overflows on the bottom surface 34a, and a space between a second end 20b of a winding portion 20 and the bottom surface 34a of the bottom wall portion 34 is easily filled with the resin 10. Therefore, heat dissipation of the coil device can be more effectively improved.

### Third Embodiment

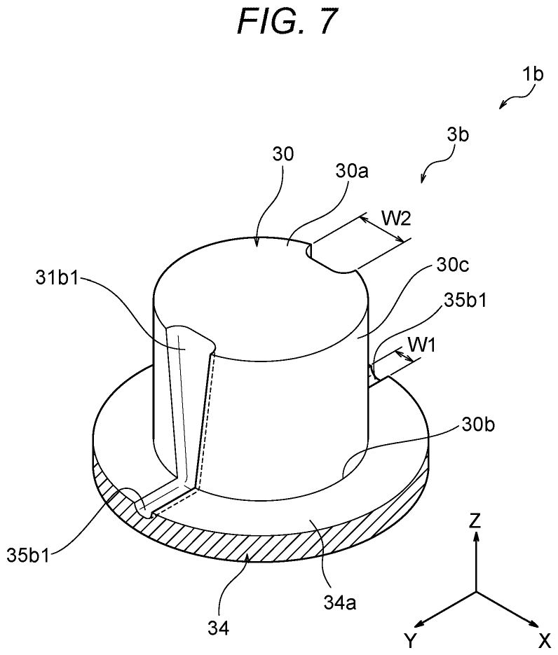

A coil device 1b of a third embodiment has a similar configuration to that of the coil device 1a of the second embodiment except for the following points. Portions overlapping with the coil device 1a of the second embodiment are denoted by the same reference signs, and a detailed description thereof will be omitted. FIG. 7 illustrates a part of an internal configuration of a first core 3b in the coil device 1b of the third embodiment.

As illustrated in FIG. 7, the coil device 1b includes the first core 3b. The first core 3b is different from the first core 3a of the second embodiment in that the first core 3b includes center core groove portions 31b1 and 31b2 and bottom groove portions 35b1 and 35b2. Each of the center core groove portions 31b1 and 31b2 has a tapered shape (inverted triangular shape) as a whole, and a width W1 of each of the center core groove portions 31b1 and 31b2 at a second end 30b of a center core portion 30 is smaller than a width W2 of each of the center core groove portions 31b1 and 31b2 at a first end 30a of the center core portion 30. That is, the width of each of the center core groove portions 31b1 and 31b2 in a direction orthogonal to an extending direction decreases toward the second end 30b of the center core portion 30. The width of each of the bottom groove portions 35b1 and 35b2 is equal to the width W1 of each of the center core groove portions 31b1 and 31b2 at the second end 30b of the center core portion 30.

Also in the present embodiment, effects similar to those of the second embodiment can be obtained. In addition, in the present embodiment, since the width W2 of each of the center core groove portions 31b1 and 31b2 is larger on a first end 30a side of the center core portion 30 (corresponding to an opening side of a cavity), when the cavity is filled with a resin 10, the resin 10 easily enters the center core groove portions 31b1 and 31b2, and a sufficient amount of resin 10 can be poured into the center core groove portions 31b1 and 31b2 and the bottom groove portions 35b1 and 35b2. Therefore, a space between a second end 20b of a winding portion 20 and a bottom surface 34a of a bottom wall portion 34 is easily filled with the resin 10.

### Fourth Embodiment

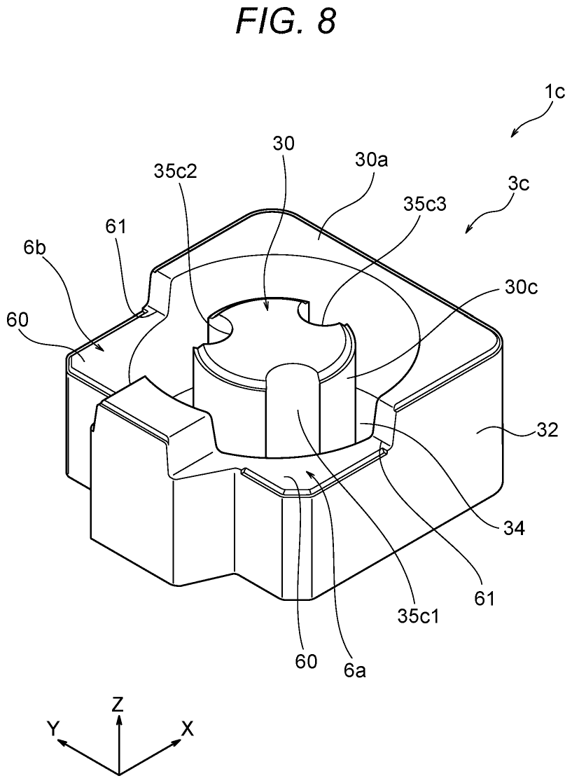

A coil device 1c of a fourth embodiment has a similar configuration to that of the coil device 1 of the first embodiment except for the following points. Portions overlapping with the coil device 1 of the first embodiment are denoted by the same reference signs, and a detailed description thereof will be omitted. FIG. 8 illustrates an internal configuration of a first core 3c in the coil device 1c of the fourth embodiment.

As illustrated in FIG. 8, the coil device 1c includes the first core 3c. The first core 3c is different from the first core 3c of the first embodiment in that the first core 3c includes center core groove portions 31c1, 31c2, and 31c3. In the first core 3c, the center core groove portions 31c1, 31c2, and 31c3 are disposed so as to be symmetric with respect to an XZ plane passing through the center of a center core portion 30. The center core groove portion 31c1 is disposed near a cutout portion 6a, and the center core groove portion 31c2 is disposed near a cutout portion 6b. With such a configuration, the coil device 1c can be easily manufactured, and the coil device lc is also excellent in heat dissipation and can be preferably used particularly at a high frequency.

The present disclosure is not limited to the above-described embodiments, and various modifications can be made within the scope of the present disclosure.

As illustrated in FIG. 2, in the first embodiment, at least a part of the leadout portion 21 is exposed to the outside through the cutout portion 6a when viewed from the direction D1. At least a part of the leadout portion 22 is exposed to the outside through the cutout portion 6b when viewed from the direction D2. However, in the present disclosure, these configurations are not essential. The leadout portion 21 may be hidden by the side wall portion 32 (third surface 32c) when viewed from the direction D1. The leadout portion 22 may be hidden by the side wall portion 32 (fourth surface 32d) when viewed from the direction D2.

As illustrated in FIG. 2, in the first embodiment, three center core groove portions 311, 312, and 313 are formed in the first core 3, but the number of center core groove portions is not limited thereto, and one or four or more center core groove portions may be formed. Further, the first core according to the first embodiment or the fourth embodiment may be a core including the bottom groove portion connected to the center core groove portion as in the second and third embodiments.

As illustrated in FIG. 2, in the first embodiment, in the center core portion 30 of the first core 3, a portion of the outer peripheral surface 30c facing the inner peripheral surface 20c of the winding portion 20 is wider than a portion where the center core groove portions 311, 312, and 313 are formed. However, the portion where the center core groove portions 311, 312, and 313 are formed may be wider than the portion of the outer peripheral surface 30c facing the inner peripheral surface 20c of the winding portion 20. That is, a position of the outer peripheral surface 30c facing the inner peripheral surface 20c of the winding portion 20 and a postion where the center core groove portions 311, 312, and 313 are formed may be interchanged.

### REFERENCE SIGNS LIST

1, 1a, 1b, 1c Coil device
2 Wire (conductor)
20 Winding portion
20a First end
20b Second end
20 Inner peripheral surface
20d Outer peripheral surface
21, 22 Leadout portion
23 Leadout position
3 First core
30 Center core portion
30a First end
30b Second end
30c Outer peripheral surface
311, 312, 313.31a1, 31a2, 31b1, 31b2, 31c1, 31c2, 31c3 Center core groove portion
32 Side wall portion
32a First surface
32b Second surface
32 Third surface
32d Fourth surface
32e End surface
32f Inner peripheral surface
34 Bottom wall portion
34a Bottom surface
34b Installation surface
35a1, 35a2, 35b1, 35b2 Bottom groove portion
36 Recessed space
4 Second core
40 Attachment surface
5a, 5b Terminal
50 Installation portion
51 First side portion
51a Narrow portion
52 Second side portion
53 Wire connecting portion
54 Crimping portion
6a, 6b Cutout portion
60 Bottom portion
61 First end
62 Second end
7 Protrusion
71 First portion
72 Second portion
73 Inclined surface
74a, 74b Recess
10 Resin (heat transfer material)
11 Melting portion

What is claimed is:

1. A coil device comprising:
a conductor including a winding portion; and
a core including a center core portion passing inside the winding portion,
wherein the center core portion includes an outer peripheral surface contacted with the winding portion and a center core groove portion recessed inward from the outer peripheral surface.

2. The coil device according to claim 1,
wherein the core includes a bottom wall portion at an end of the center core portion, and
the bottom wall portion includes a bottom surface contacted with the winding portion and a bottom groove portion recessed from the bottom surface.

3. The coil device according to claim 2, wherein the center core groove portion and the bottom groove portion are connected to each other.

4. The coil device according to claim 1, wherein the number of center core groove portions is plural.

5. The coil device according to claim 1, wherein the core is a pot core including a side wall portion surrounding the center core portion, and
the core has a recessed space formed between the center core portion and the side wall portion.

6. The coil device according to claim 5, further comprising a second core attached to the side wall portion,
wherein the side wall portion has a cutout portion, and
the winding portion includes leadout portions extending substantially linearly along a tangent line of the center core portion and led out toward the cutout portion.

7. The coil device according to claim 6, wherein the center core groove portion is near the cutout portion.

8. The coil device according to claim 1, wherein a heat transfer material having a higher thermal conductivity than air is filled in the center core groove portion.

9. The coil device according to claim 8, wherein the heat transfer material is in contact with the winding portion.

10. The coil device according to claim 9, wherein the heat transfer material contains a filler-containing resin.
